(19) United States
(12) Patent Application Publication
(10) Pub. No.: US 2008/0027200 A1
(43) Pub. Date: Jan. 31, 2008

(54) PHOSPHOR-CONTAINING CURABLE SILICONE COMPOSITION FOR LED AND LED LIGHT-EMITTING DEVICE USING THE COMPOSITION

(75) Inventors: Katsuyuki IMAZAWA, Takasaki-shi (JP); Tsutomu KASHIWAGI, Annaka-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Shin -Etsu Chemical Co., Ltd., Chiyoda-ku (JP)

(21) Appl. No.: 11/782,859

(22) Filed: Jul. 25, 2007

(30) Foreign Application Priority Data
Jul. 26, 2006 (JP) 2006-202744

(51) Int. Cl. C09K 11/02; C08G 77/04

(52) U.S. Cl. 528/15; 252/301.36

(57) ABSTRACT

Disclosed are a curable silicone composition for an LED and an LED light-emitting device that uses such a composition as a sealing material.

A curable silicone composition for sealing an LED is disclosed that comprises a phosphor and an inorganic ion exchanger, wherein the quantity of the inorganic ion exchanger is within a range from 0.1 to 50% by mass. This composition is ideal for sealing an LED element in an LED light-emitting device. Corrosion of metal electrodes and the like does not occur even in the presence of red phosphors that contain sulfur.

### BACKGROUND OF THE INVENTION

1. Field of the Invention

The present invention relates to a phosphor-containing curable silicone composition for use with an LED, and relates more particularly to a curable silicone composition in which the color of the light emitted by the LED chip is changed by including a phosphor within the silicone composition, as well as an LED light-emitting device that uses such a composition.

2. Description of the Prior Art

In conventional LED light-emitting devices that use this type of phosphor-containing curable silicone composition, the LED chip that is mounted on the package is covered with a translucent molded member that protects the LED chip from the outside environment. A suitable quantity of a phosphor, for example a quantity within a range from 0.3 to 30% by mass, is incorporated within this molded member. The action of this phosphor in shifting the wavelength of the light emitted from the LED to a longer wavelength is utilized to change or adjust the color of the emitted light. In conventional examples of this type of LED light-emitting device, a yellow YAG phosphor is usually incorporated within the molded member, although in recent years, in order to achieve improved color rendering, red phosphors containing sulfur have also started to be used in combination with these yellow phosphors. However, the use of these red phosphors tends to cause corrosion as a result of sulfurization of the metal members such as metal electrodes, meaning the long-term reliability of the light-emitting device tends to deteriorate.

### SUMMARY OF THE INVENTION

Accordingly, an object of the present invention is to provide a curable silicone composition for an LED that enables the metal members such as metal electrodes to be protected from corrosion, even in the presence of red phosphors that contain sulfur.

As a result of intensive investigation aimed at resolving the problem described above, the inventors of the present invention discovered that by dispersing, within the silicone composition, an inorganic ion exchanger capable of preventing corrosion of the metal electrodes, the above object could be achieved, and they were therefore able to complete the present invention.

In other words, the present invention provides a curable silicone composition for sealing an LED, wherein the composition comprises a phosphor and an inorganic ion exchanger, and the quantity of the inorganic ion exchanger is within a range from 0.1 to 50% by mass.

The composition stated above is used, in a light-emitting device comprising an LED element, and a cured product of a curable silicone composition that seals said LED element, as said curable silicone composition.

In the present invention, the curable silicone composition used for coating an LED element comprises a phosphor and an inorganic ion exchanger that has the function of preventing sulfurization of the metal electrodes, and consequently sulfurization and corrosion of the metal electrodes within the light-emitting device can be prevented even in those cases where a red phosphor containing sulfur is used as the phosphor. As a result, the reliability of the LED light-emitting device improves markedly.

### BRIEF DESCRIPTION OF THE DRAWINGS

FIG. 1 is a schematic cross-sectional view showing an embodiment of a phosphor-containing LED light-emitting device according to the present invention.

### DETAILED DESCRIPTION OF THE PREFERRED EMBODIMENTS

In the following description, the term “weight average molecular weight” refers to polystyrene equivalent weight average molecular weight values measured by gel permeation chromatography.

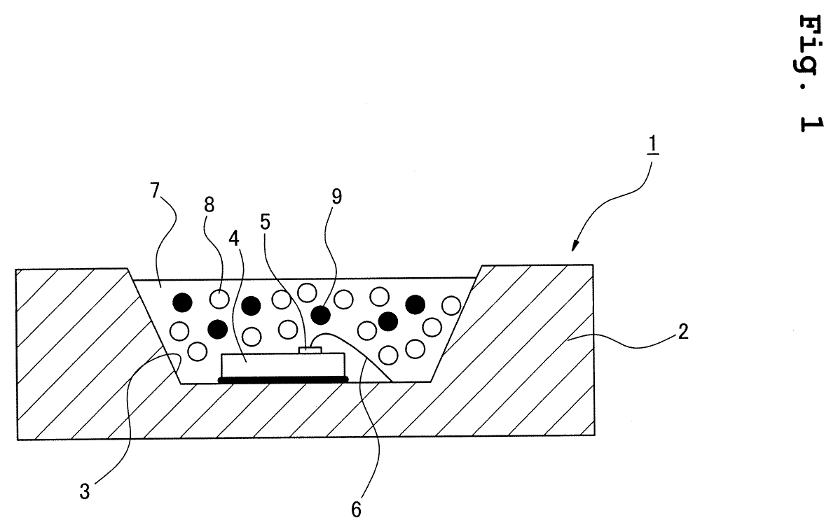

A detailed description of the present invention is provided below, based on the embodiment shown in FIG. 1. FIG. 1 is a schematic cross-sectional view showing the structure of an LED light-emitting device according to the present invention. In FIG. 1, an LED light-emitting device 1 comprises an LED chip 4 mounted to a lead frame on the bottom flat surface of a concave portion 3 provided in the center of a package 2. An electrode 5 on top of the LED chip 4 is connected to an electrode (not shown in the figure) provided on top of the package 2 via a conductive wire 6. The LED chip 4 is covered with a cured product 7 of a curable silicone composition that contains a phosphor. A phosphor 8 and an inorganic ion exchanger 9 are added to, and dispersed within, the cured product 7 of the curable silicone composition.

—Phosphor—

The phosphor used in the curable silicone composition of the present invention may be any conventional phosphor comprising sulfur or a rare earth element, and inorganic phosphors are ideal. Specifically, one or more phosphors containing either S, or at least one element selected from the group consisting of Y, Cd, Tb, La, Lu, Se and Sm can be used, and particularly representative phosphors include yellow YAG phosphors and calcium sulfide red phosphors.

The phosphor used in the present invention typically has a particle size, measured using a particle size distribution measurement method such as a laser diffraction method, that is 10 nm or greater, preferably from 10 nm to 10 μm, and even more preferably from 10 nm to 1 μm. The blend quantity of the phosphor within the curable silicone composition is typically within a range from 0.1 to 50% by mass, and is preferably from 0.2 to 25% by mass.

—Inorganic Ion Exchanger—

The inorganic ion exchanger added to the curable silicone composition of the present invention is preferably an inorganic anion exchanger or an inorganic amphoteric ion exchanger.

Examples of suitable inorganic ion exchangers include the compounds described below. Namely, examples include aluminosilicates such as natural zeolites and synthetic zeolites; metal oxides such as aluminum oxide and magnesium oxide; hydroxides or hydrous oxides such as hydrous titanium oxide, hydrous bismuth oxide, hydrous antimony oxide, hydrous aluminum oxide, hydrous magnesium oxide and hydrous zirconium oxide; metal acid salts such as zirconium phosphate and titanium phosphate; basic salts and complex hydrous oxides of hydrotalcites; hetero polyphosphates such as ammonium molybdophosphate; or hexacyano iron (III) or hexacyano zinc. Of these, from the viewpoints of ensuring favorable chemical resistance and minimizing ionic impurities under moisture-resistant conditions, a metal hydroxide or hydrous oxide is preferred, and of these, antimony-free ion exchangers such as bismuth-based, aluminum-based, magnesium-based and zirconium-based inorganic ion exchangers are particularly desirable (for example, one or more metal hydrous oxides or hydroxides selected from the group consisting of antimony-free hydrous bismuth oxide (or bismuth hydroxide (subsequent hydrous oxides are also deemed to include the equivalent hydroxide)), hydrous aluminum oxide, hydrous magnesium oxide, hydrous zirconium oxide and mixtures thereof).

Specific examples of these antimony-free bismuth-based, aluminum-based, magnesium-based or zirconium-based inorganic ion exchangers include the IXE range of products available from Toagosei Co., Ltd., including the product names IXE500, IXE530, IXE550, IXE700, IXE700F and IXE800.

Examples of the hydrotalcite-based compounds mentioned above include compounds with a layered structure comprising magnesium and aluminum, and commercially available products include KW2200, KW2100, DHT-4A, DHT-4B and DHT-4C (manufactured by Kyowa Chemical Industry Co., Ltd.).

These inorganic ion exchangers typically have an average particle size of not more than 5 μm, typically within a range from 0.01 to 5 μm, and preferably from 0.1 to 5 μm. Furthermore, any of the inorganic ion exchangers described above may be used alone, or within a combination containing two or more different ion exchangers. In this description, the average particle size refers, for example, to the accumulated weight average value D₅₀ (or median diameter) measured by a particle size distribution analyzer using a laser diffraction method.

In order to ensure a favorable impurity ion-trapping effect and favorable mechanical properties for the silicone rubber obtained upon curing the composition, the quantity of the inorganic ion exchanger within the addition curable silicone composition is preferably within a range from 0.1 to 50% by mass, and is even more preferably from 0.5 to 30% by mass.

—Curable Silicone Composition—

An example of the curable silicone composition used in the present invention is an addition curable silicone resin. An example of an addition curable silicone resin is a resin that is cured by reacting (via a hydrosilylation addition reaction) a straight-chain diorganopolysiloxane containing alkenyl groups such as vinyl groups at both molecular chain terminals, at non-terminal positions within the molecular chain, or at both the molecular chain terminals and non-terminal positions within the molecular chain, with an organohydrogenpolysiloxane in the presence of a platinum group metal-based catalyst.

A specific example of this type of addition curable silicone composition is a resin composition comprising:

(a) an organopolysiloxane containing two or more alkenyl groups bonded to silicon atoms within each molecule,
(b) an organohydrogenpolysiloxane containing two or more hydrogen atoms bonded to silicon atoms (namely, SiH groups) within each molecule,

in sufficient quantity that the molar ratio of hydrogen atoms bonded to silicon atoms within this component (b) relative to alkenyl groups bonded to silicon atoms within the component (a) is within a range from 0.1 to 5.0, and

(c) an effective quantity of a platinum group metal-based catalyst.

A more detailed description of the components (a) to (c) is provided below.

### —Component (a)

Examples of the organopolysiloxane of the component (a) that contains two or more alkenyl groups bonded to silicon atoms within each molecule include conventional organopolysiloxanes used as the base polymers within these types of curable silicone compositions. These organopolysiloxanes typically have a weight average molecular weight within a range from approximately 3,000 to 300,000, and a viscosity at room temperature (25° C.) within a range from 100 to 1,000,000 mPa·s, and preferably from 200 to 100,000 mPa·s. Examples of the organopolysiloxane include compounds represented by an average composition formula (1) shown below.

R¹ₐSiO_{(4-a)/2} (1)

(wherein, R¹ represents identical or different, unsubstituted or substituted monovalent hydrocarbon groups of 1 to 10 carbon atoms, and preferably 1 to 8 carbon atoms, and a represents a positive number within a range from 1.5 to 2,8, preferably from 1.8 to 2.5, and even more preferably from 1.95 to 2.05)

Examples of the unsubstituted or substituted monovalent hydrocarbon groups bonded to silicon atoms represented by R¹ include alkyl groups such as a methyl group, ethyl group, propyl group, isopropyl group, butyl group, isobutyl group, tert-butyl group, pentyl group, neopentyl group, hexyl group, cyclohexyl group, octyl group, nonyl group or decyl group; aryl groups such as a phenyl group, tolyl group, xylyl group or naphthyl group; aralkyl groups such as a benzyl group, phenylethyl group or phenylpropyl group; alkenyl groups such as a vinyl group, allyl group, propenyl group, isopropenyl group, butenyl group, hexenyl group, cyclohexenyl group or octenyl group; and groups in which either a portion of, or all of, the hydrogen atoms within the above hydrocarbon groups have been substituted with a halogen atom such as a fluorine, bromine or chlorine atom, or a cyano group or the like, including a chloromethyl group, chloropropyl group, bromoethyl group, trifluoropropyl group, or cyanoethyl group. In the present description, the terms “alkyl group” and “alkenyl group” are deemed to include cycloalkyl groups and cycloalkenyl groups respectively.

At least two of the R¹ groups within the organopolysiloxane represented by the general formula (1) must represent alkenyl groups (which preferably contain from 2 to 8 carbon atoms, and even more preferably from 2 to 6 carbon atoms). The alkenyl group quantity relative to the total of all organic groups bonded to silicon atoms (that is, the proportion of alkenyl groups amongst all the unsubstituted and substituted monovalent hydrocarbon groups represented by R¹ within the above average composition formula (1)) is typically within a range from 0.01 to 20 mol %, and is preferably from 0.1 to 10 mol %. The alkenyl groups may be bonded to silicon atoms at the molecular chain terminals, to silicon atoms within the molecular chain (namely, non-terminal positions within the molecular chain), or to both these types of silicon atoms. However, from the viewpoints of the composition curing rate and the physical properties of the resulting cured product, the organopolysiloxane preferably contains alkenyl groups bonded to at least the silicon atoms at the molecular chain terminals. The alkenyl groups are preferably vinyl groups, and the other substituent groups are preferably methyl groups and/or phenyl groups.

The organopolysiloxane is preferably a diorganopolysiloxane with a basically straight-chain structure, in which the principal chain comprises repeating diorganosiloxane units ((R¹)₂SiO_{2/2} units), and both molecular chain terminals are blocked with triorganosiloxy groups ((R¹)₃SiO_{1/2} units). The organopolysiloxane may include partial branched structures or cyclic structures comprising R¹SiO_{3/2} units and/or SiO_{4/2} units, but even in these cases, the structure preferably contains mainly (R¹)₂SiO_{2/2} units, and is preferably essentially a straight-chain structure.

Specific examples of the organopolysiloxane of the component (a) include compounds represented by the general formulas shown below.

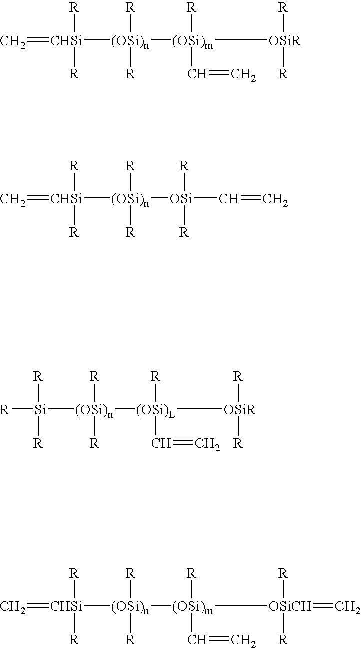

In the above general formulas, R has the same meaning as R¹ with the exception of not including alkenyl groups, and L, m and n are integers that satisfy L≧2, m≧1 and n≧0 respectively, and the values of n, L+n, and m+n are numbers that enable the molecular weight and viscosity of the organopolysiloxane to satisfy the values described above.

### —Component (b)

The organohydrogenpolysiloxane of the component (b) is an organohydrogenpolysiloxane containing two or more hydrogen atoms bonded to silicon atoms (SiH groups) within each molecule. The component (b) reacts with the component (a) and functions as a cross-linking agent. There are no particular restrictions on the molecular structure of the organohydrogenpolysiloxane, and conventionally produced straight-chain, cyclic, branched, or three dimensional network (resin-like) structures can be used. The organohydrogenpolysiloxane must contain two or more hydrogen atoms bonded to silicon atoms (SiH groups) within each molecule, and preferably contains from 2 to 200, and even more preferably from 3 to 100, of these SiH groups. Examples of this organohydrogenpolysiloxane include compounds represented by an average composition formula (2) shown below.

R¹_{b}H_{c}SiO_{(4-b-c)/2} (2)

In the above formula (2), R² represents an unsubstituted or substituted monovalent hydrocarbon group of 1 to 10 carbon atoms. Examples of the group R² include the same groups as those described above for the group R¹ within the above formula (1). Furthermore, b is a positive number within a range from 0.7 to 2.1, c is a positive number within a range from 0.001 to 1.0, and b+c is a positive number within a range from 0.8 to 3.0. Moreover, b is preferably from 1.0 to 2.0, c is preferably from 0.01 to 1.0, and b+c is preferably from 1.5 to 2.5.

The two or more, and preferably three or more, SiH groups contained within each molecule may be located at the molecular chain terminals or at positions within the molecular chain (namely, non-terminal positions within the molecular chain), or may also be located at both these positions. Furthermore, the molecular structure of this organohydrogenpolysiloxane may be any one of a straight-chain, cyclic, branched or three dimensional network structure, although the number of silicon atoms within each molecule (namely, the polymerization degree) is typically within a range from 2 to 300, and is preferably from 4 to 150. The organohydrogenpolysiloxane is preferably a liquid at room temperature (25° C.).

Specific examples of organohydrogenpolysiloxanes of the formula (2) include 1,1,3,3-tetramethyldisiloxane, 1,3,5,7-tetramethylcyclotetrasiloxane, tris(hydrogendimethylsiloxy)methylsilane, tris(hydrogendimethylsiloxy)phenylsilane, methylhydrogencyclopolysiloxane, cyclic copolymers of methylhydrogensiloxane and dimethylsiloxane, methylhydrogenpolysiloxane with both terminals blocked with trimethylsiloxy groups, copolymers of dimethylsiloxane and methylhydrogensiloxane with both terminals blocked with trimethylsiloxy groups, dimethylpolysiloxane with both terminals blocked with dimethylhydrogensiloxy groups, copolymers of dimethylsiloxane and methylhydrogensiloxane with both terminals blocked with dimethylhydrogensiloxy groups, copolymers of methylhydrogensiloxane and diphenylsiloxane with both terminals blocked with trimethylsiloxy groups, copolymers of methylhydrogensiloxane, diphenylsiloxane and dimethylsiloxane with both terminals blocked with trimethylsiloxy groups, copolymers of methylhydrogensiloxane, methylphenylsiloxane and dimethylsiloxane with both terminals blocked with trimethylsiloxy groups, copolymers of methylhydrogensiloxane, dimethylsiloxane and diphenylsiloxane with both terminals blocked with dimethylhydrogensiloxy groups, copolymers of methylhydrogensiloxane, dimethylsiloxane and methylphenylsiloxane with both terminals blocked with dimethylhydrogensiloxy groups, copolymers comprising (CH₃)₂HSiO_{1/2} units, (CH₃)₃SiO_{1/2} units, and SiO_{4/2} units, copolymers comprising (CH₃)₂HSiO_{1/2} units and SiO_{4/2} units, and copolymers comprising (CH₃)₂HSiO_{1/2} units, SiO_{4/2} units, and (C₆H₅)₃SiO_{1/2} units.

The quantity added of the component (b) must be sufficient that the molar ratio of hydrogen atoms bonded to silicon atoms within the component (b) relative to alkenyl groups bonded to silicon atoms within the component (a) is within a range from 0.1 to 5.0, preferably from 0.5 to 3.0, and even more preferably from 0.8 to 2.0. If this molar ratio is less than 0.1, then the resulting cross-linking density is too low, which has an adverse effect on the heat resistance of the cured silicone rubber. In contrast, if the molar ratio exceeds 5.0, then foaming problems caused by a dehydrogenation reaction may occur, and the heat resistance of the resulting cured product may deteriorate.

### —Component (c)

The platinum group metal-based catalyst of the component (c) is used for accelerating the curing addition reaction (the hydrosilylation reaction) between the component (a) and the component (b). Conventional catalysts can be used for this platinum group metal-based catalyst, although the use of platinum or a platinum compound is preferred. Specific examples of suitable platinum compounds include platinum black, platinic chloride, chloroplatinic acid, alcohol-modified chloroplatinic acid, and coordination compounds of chloroplatinic acid with olefins, aldehydes, vinylsiloxanes or acetylene alcohols.

The quantity added of the platinum group metal-based catalyst need only be sufficient to be effective in accelerating the above curing reaction, and this quantity will be either self-evident to, or readily determinable by, those skilled in the art. Specifically, the quantity added typically yields a mass of platinum relative to the component (a) that falls within a range from 0.1 to 1,000 ppm (calculated by mass), and preferably from 1 to 200 ppm. This quantity may be altered in accordance with the desired curing rate.

### —Other Components

Furthermore, in addition to the components described above, other optional components may also be added to the composition of the present invention as required, provided such addition does not impair the objects or effects of the present invention. Examples of these other components include the types of reaction retarders used within conventional addition curable silicone compositions, and components that are conventionally added to impart or improve the adhesion of the composition, such as alkoxysilanes and silane coupling agents.

### EXAMPLES

Next is a more detailed description of the present invention using a series of examples, although the present invention is in no way limited by the examples presented below. In the following examples, “parts” refers to “parts by mass”, Me represents a methyl group, and Et represents an ethyl group.

### Example 1

To 100 parts of a dimethylpolysiloxane with both terminals blocked with vinyldimethylsiloxy groups, represented by an average molecular formula (i) shown below:

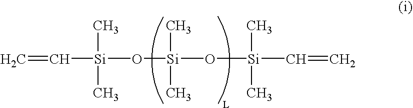

(wherein, L (average value)=450)
was added an organohydrogenpolysiloxane represented by an average molecular formula (ii) shown below:

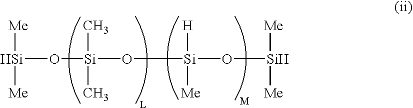

(wherein, M (average value)=10, and N (average value)=8)

in sufficient quantity that the molar ratio of SiH groups within this organohydrogenpolysiloxane relative to the vinyl groups within the vinyl group-containing dimethylpolysiloxane of the above formula (i) was 1.5, together with 0.05 parts of an octyl alcohol-modified solution of chloroplatinic acid, 3 parts of a YAG phosphor, and 3 parts of a calcium sulfide phosphor, and the resulting mixture was stirred thoroughly to form a mixture. To 100 parts of the thus obtained mixture was added 1 part of an antimony-free magnesium-based inorganic ion exchanger (product name: IXE700F, manufactured by Toagosei Co., Ltd.), thus completing preparation of a phosphor-containing silicone rubber composition.

### Examples 2 to 5

In the examples 2 to 5, with the exception of altering the quantity added of the magnesium-based inorganic ion exchanger to 2, 5, 10 and 30 parts respectively relative to the 100 parts of the above mixture, liquid phosphor-containing silicone rubber compositions were prepared in the same manner as the example 1.

### Comparative Example 1

With the exception of not adding the magnesium-based inorganic ion exchanger IXE700F, a phosphor-containing silicone rubber composition was prepared in the same manner as the example 1.

### Comparative Example 2

With the exception of adding only 0.05 parts of the magnesium-based inorganic ion exchanger IXE700F to 100 parts of the above mixture, a phosphor-containing silicone rubber composition was prepared in the same manner as the example 1.

### Comparative Example 3

With the exception of adding 60 parts of the magnesium-based inorganic ion exchanger IXE70° F. to 100 parts of the above mixture, a phosphor-containing silicone rubber composition was prepared in the same manner as the example 1.

The compositions obtained in each of the above examples and comparative examples were subjected to the evaluations described below.

### —Properties of the Cured Product

Each composition was cured by heating at 80° C. for 4 hours, and the hardness, elongation and tensile strength of the resulting cured product were measured in accordance with JIS K6301. The hardness was measured using a spring Type A hardness tester. The results are shown in Table 1.

### —Corrosion Test

Each composition was applied at a thickness of 1.0 mm to the surface of a silver-plated copper substrate, and the thus formed composition layer was then cured by heating at 100° C. for one hour, thus forming an evaluation sample. This evaluation sample was then left to stand for 96 hours inside a constant temperature and humidity chamber at a temperature of 85° C. and a humidity of 85% RH, as shown in Table 2. In this test, 0 hours represents the initial state of the evaluation sample. The state of corrosion on the silver-plated copper substrate was evaluated periodically. The results are shown in Table 2.

TABLE 1

| | | | | | | | Comparative | Comparative | Comparative |
|---|---|---|---|---|---|---|---|---|---|
| | | Example 1 | Example 2 | Example 3 | Example 4 | Example 5 | example 1 | example 2 | example 3 |
| Cured Product | Hardness | 22 | 23 | 22 | 21 | 22 | 22 | 23 | 35 |
| Properties | (Type A) | | | | | | | | |
| | Elongation | 150 | 145 | 150 | 155 | 155 | 150 | 150 | 60 |
| | (%) | | | | | | | | |
| | Tensile strength | 0.8 | 0.7 | 0.9 | 0.9 | 0.9 | 0.8 | 0.8 | 1.5 |
| | (MPa) | | | | | | | | |

TABLE 2

| | | | | | | | Comparative | Comparative | Comparative |
|---|---|---|---|---|---|---|---|---|---|
| | | Example 1 | Example 2 | Example 3 | Example 4 | Example 5 | example 1 | example 2 | example 3 |
| Standing | 0 hr | ∘ | ∘ | ∘ | ∘ | ∘ | ∘ | ∘ | ∘ |
| time | 24 hr | ∘ | ∘ | ∘ | ∘ | ∘ | Δ | ∘ | ∘ |
| | 48 hr | ∘ | ∘ | ∘ | ∘ | ∘ | x | Δ | ∘ |
| | 72 hr | ∘ | ∘ | ∘ | ∘ | ∘ | x | x | ∘ |
| | 96 hr | ∘ | ∘ | ∘ | ∘ | ∘ | x | x | ∘ |

∘: no corrosion,
Δ: partial discoloration,
x: black discoloration (complete corrosion)

### [Evaluation Results]

The mechanical properties of the silicone rubbers obtained from the compositions of the examples 1 to 5 showed absolutely no deterioration in mechanical properties when compared with the silicone rubber of the comparative example 1 that contained no inorganic ion exchanger.

The silver-plated substrates covered with the compositions of the examples 1 to 5 suffered no corrosion of the silver plating even after standing for 96 hours. In contrast, in the comparative examples 1 and 2, although there was no deterioration in the mechanical properties of the silicone rubber, corrosion of the silver plating caused by sulfurization was observed. Furthermore in the comparative example 3, although corrosion of the silver plating caused by sulfurization was not observed, the mechanical properties of the silicone rubber were inferior to those of the comparative example 1.

As described above, by covering the substrate with a phosphor-containing silicone composition of the present invention that includes from 0.1 to 50% by mass of an inorganic ion exchanger in addition to the phosphor, the conventional problem of corrosion of the metal electrodes caused by sulfurization was able to be prevented. As a result, the long-term reliability of LED light-emitting devices can be improved.

What is claimed is:

1. A curable silicone composition for sealing an LED, wherein said composition comprises a phosphor and an inorganic ion exchanger, and a quantity of said inorganic ion exchanger is within a range from 0.1 to 50% by mass.

2. The curable silicone composition according to claim 1, wherein said inorganic ion exchanger is an anion exchanger or an amphoteric ion exchanger.

3. The curable silicone composition according to claim 1, wherein said inorganic ion exchanger is an antimony-free ion exchanger selected from the group consisting of bismuth-based inorganic ion exchangers, aluminum-based inorganic ion exchangers, magnesium-based inorganic ion exchangers, and zirconium-based inorganic ion exchangers.

4. The curable silicone composition according to claim 1, wherein said inorganic ion exchanger is a metal hydroxide or a hydrous metal oxide.

5. The curable silicone composition according to claim 1, wherein said composition comprises:
(a) an organopolysiloxane containing two or more alkenyl groups bonded to silicon atoms within each molecule,
(b) an organohydrogenpolysiloxane containing two or more hydrogen atoms bonded to silicon atoms within each molecule,
in sufficient quantity that a molar ratio of said hydrogen atoms bonded to silicon atoms relative to said alkenyl groups bonded to silicon atoms within component (a) is within a range from 0.1 to 5.0,
(c) an effective quantity of a platinum group metal-based catalyst,
(d) a phosphor, and
(e) an inorganic ion exchanger.

6. The composition according to claim 1, which is used, in a light-emitting device comprising an LED element, and a cured product of a curable silicone composition that seals said LED element, as said curable silicone composition.
